(19) United States
(12) Patent Application Publication
(10) Pub. No.: US 2020/0368962 A1
(43) Pub. Date: Nov. 26, 2020

(54) SYSTEMS, DEVICES, AND METHODS FOR 3D PRINTING BY HARNESSING DEFORMATION, INSTABILITY, AND FRACTURE OF VISCOELASTIC INKS

(71) Applicant: Massachusetts Institute of Technology, Cambridge, MA (US)

(72) Inventors: Hyunwoo Yuk, Cambridge, MA (US); Xuanhe Zhao, Allston, MA (US)

(21) Appl. No.: 16/761,643

(22) PCT Filed: Dec. 3, 2018
(86) PCT No.: PCT/US18/63697

§ 371 Date: May 5, 2020

Related U.S. Application Data
(60) Provisional application No. 62/594,516, filed on Dec. 4, 2017.

(51) Int. Cl. B29C 64/118; B29C 64/393; B33Y 10/00; B33Y 50/02; B33Y 70/00; B33Y 30/00; B29C 64/209

(52) U.S. Cl. CPC B29C 64/118; B29C 64/393; B33Y 10/00; B29C 64/209; B33Y 70/00; B33Y 30/00; B33Y 50/02

(57) ABSTRACT

Systems and methods for three-dimensionally printing different configurations of a printed fiber using a single nozzle are provided. The provided systems and methods harness deformation, instability, and fracture of viscoelastic materials to adjust dimensionless parameters related to a speed of extrusion and a height of a nozzle to create the different configurations. A controller of the system can operate to create these different configurations using the single nozzle without having to change out hardware during the process. Instead, the dimensionless parameters can be adjusted while the printing is occurring to achieve the different configurations. The disclosure provides various systems for carrying out the printing, and methods of using the same.

### CROSS REFERENCE TO RELATED APPLICATION

The present application is a U.S. national stage of and claims priority to International Patent Application No. PCT/US18/63697, filed Dec. 3, 2018, and titled “Systems, Devices, and Methods for 3D Printing by Harnessing Deformation, Instability, and Fracture of Viscoelastic Inks,” which claims priority to and the benefit of U.S. Provisional Application No. 62/594,516, filed Dec. 4, 2017, and titled “Systems, Devices, and Methods for 3D Printing by Harnessing Deformation, Instability, and Fracture of Viscoelastic Inks,” the contents of each which is hereby incorporated by reference in their entireties.

### GOVERNMENT RIGHTS

This invention was made with Government support under Grant No. CMMI 1661627 awarded by the National Science Foundation, and under Grant No. N00014-17-1-2920 award by the Office of Naval Research. The Government has certain rights in the invention.

### FIELD

The present disclosure relates to systems, devices, and methods for printing in three dimensions, and more particularly relies on harnessing deformation, instability, and fracture of viscoelastic inks to improve the capabilities and versatility of direct ink writing, allowing for higher resolution, more diverse printing by a three dimensional printer without having to change the hardware of the printer to achieve the versatility.

### BACKGROUND

There are a variety of techniques utilized to print three-dimensionally. One such technique is direct ink writing (DIW), which can allow for three-dimensional (3D) printing of multi-material and multi-functional structures capable of being used in diverse fields including stretchable electronics, organ on a chip, soft robotics, biomedical implants, and smart composites, among others. The materials that can be used in such multi-material printing include conductive pasts, elastomers, and hydrogels. During DIW printing, pressurized viscoelastic inks are extruded out of one or more nozzles, such as nozzles associated with a printhead, in the form of printed fibers. The fibers can be deposited into patterns based on a prescribed motion of the nozzles. In most DIW printing processes, a single set of printing conditions is adopted through trials and errors, and such conditions are rarely changed during the printing process. As a result, the resolution of printed fibers is usually limited by the nozzle's diameter, and the printer pattern is limited by the nozzle's motion paths. Such limitations have greatly restricted the versatility and applications of DIW three-dimensional printing approaches.

Accordingly, there is a need to improve DIW three-dimensional printing systems and methods to allow for more versatility in the types of objects that can be printed without sacrificing efficiency (i.e., without having to change hardware during the printing process) so the resulting printed objects can be of a better quality and be more dynamic.

### SUMMARY

DIW three-dimensional printing systems and methods are provided in the present disclosure that are clear improvements over existing DIW systems and methods at least because they are more versatile, thus allowing for quicker and higher quality production of three-dimensional objects. These improvements result from harnessing characteristics and properties of viscoelastic materials (e.g., viscoelastic inks) such as deformation, instability, and fracture to provide parameters under which various configurations of printed fibers can be produced. The dimensionless parameters relate to a speed of extrusion (e.g., the speed of the nozzle and the speed at which the material is deposited out of the nozzle), referred to herein as the dimensionless parameter V*, and a height of a nozzle with respect to a surface or material onto which the material is being deposited, referred to herein as the dimensionless parameters H*. The printed fiber configurations provided include, but are not limited to: accumulation, translating coiling, alternating coiling, stretching coiling, meandering, die-swelling, equi-dimensional, thinning, and discontinuous, among other possible printing modes. Although the present disclosure primarily describes the properties of deformation, instability, and fracture being associated with viscoelastic materials, a person skilled in the art will recognize other materials may also have such properties that can be harnessed in a manner similar to as provided for herein without departing from the spirit of the present disclosure.

The provided systems and methods allow for highly tunable and repeatable printing, and permit the ability to print stretchable structures with tunable stiffening, as well as 3D structures with gradient properties and programmable swelling properties. To the extent such structures can printed three-dimensionally using known systems and methods, such systems and methods are generally not capable of such versatility, tenability, and repeatability using a single nozzle, or a combination of single nozzles that each have this capability. Rather, previously existing systems and methods typically rely on changes to hardware (e.g., different nozzles) to achieve the printed fibers that are produced in accordance with the present disclosures.

In one exemplary embodiment of a method for printing in three dimensions, the method includes selecting a printing mode based on at least one of a non-dimensional nozzle speed and a non-dimensional nozzle tip height. The non-dimensional nozzle speed is based on both a nozzle speed and an extrusion speed, while the non-dimensional nozzle tip height is based on both a die-swollen diameter of material to be extruded from a nozzle and a combination of a height of a substrate configured to receive extruded material from the nozzle and a height of material disposed on the substrate. The method also includes depositing material from the nozzle based on the selected printing mode.

Depositing material from the nozzle based on the selected printing mode can include depositing the material in one or more of the following manners: accumulation, translating coiling, alternating coiling, stretching coiling, meandering, die-swelling, equi-dimensional, thinning, and discontinuous, among others. Selecting a printing mode based on at least one of a non-dimensional nozzle speed and a non-dimensional nozzle tip height can include selecting values of at least one of the non-dimensional nozzle speed and the non-dimensional nozzle tip height based on at least one of the following properties of the material to be deposited from the nozzle: a deformation of the material, an instability of the material, and/or a fracture of the material. The material that is deposited can include a viscoelastic ink.

The method can include generating a phase diagram for material to be printed from the nozzle. The phase diagram can include a plurality of printing modes from which the printing mode can be selected based on the non-dimensional nozzle speed and the non-dimensional nozzle tip height. At least one printing mode can be based on a ratio that includes the non-dimensional nozzle speed and the non-dimensional nozzle tip. Additionally, or alternatively, at least one printing mode can be based on a comparison between the non-dimensional nozzle speed and a die-swelling ratio. Still further additionally, or alternatively, at least one printing mode can be based on a comparison between the non-dimensional nozzle speed and the actual nozzle speed.

One exemplary embodiment of a three-dimensional printing system includes a printhead and a controller. The printhead includes one or more nozzles. The controller is configured to operate the printhead to eject ink from the one or more nozzles towards a surface. The controller is further configured to print in a variety of different printing modes without changing hardware of the system, including hardware of the printhead and the one or more nozzles. While many different printing modes are achievable, they include accumulation, translating coiling, alternating coiling, stretching coiling, meandering, die-swelling, equi-dimensional, thinning, and discontinuous.

In some embodiments, the controller can be configured to print at least each of the variety of different printing modes. Those modes can include accumulation, translating coiling, alternating coiling, stretching coiling, meandering, die-swelling, equi-dimensional, thinning, and discontinuous, among others. Ink ejected by the one or more nozzles can include a viscoelastic ink. In some embodiments, the system can include a viscoelastic ink, with the viscoelastic ink being configured to be the ink ejected by the one or more nozzles.

The controller can be further configured to select a printing mode from the variety of different printing modes. The selection can be based on at least one of a non-dimensional nozzle speed and a non-dimensional nozzle tip height of at least one nozzle of the one or more nozzles. The non-dimensional nozzle speed can be based on both a nozzle speed and an extrusion speed, and the non-dimensional nozzle tip height can be based on both a die-swollen diameter of material to be extruded from the at least one nozzle and a combination of a height of a substrate configured to receive extruded material from the at least one nozzle and a height of material disposed on the substrate. In some such embodiments, the controller can be configured such that it selects values of at least one of the non-dimensional nozzle speed and the non-dimensional nozzle tip height based on at least one of the following properties of the material to be deposited from the nozzle: a deformation of the material, an instability of the material, and/or a fracture of the material.

In some embodiments, the controller can be configured to generate a phase diagram for material to be printed from the one or more nozzles. The phase diagram can include at least one printing mode from the variety of different printing modes. The phase diagram can be based on at least one of a non-dimensional nozzle speed and a non-dimensional nozzle tip height of at least one nozzle of the one or more nozzles. The non-dimensional nozzle speed can be based on both a nozzle speed and an extrusion speed, and the non-dimensional nozzle tip height can be based on both a die-swollen diameter of material to be extruded from the at least one nozzle and a combination of a height of a substrate configured to receive extruded material from the at least one nozzle and a height of material disposed on the substrate. At least one printing mode can be based on a ratio that includes the non-dimensional nozzle speed and the non-dimensional nozzle tip. Additionally, or alternatively, at least one printing mode can be based on a comparison between the non-dimensional nozzle speed and a die-swelling ratio. Still further additionally, or alternatively, at least one printing mode can be based on a comparison between the non-dimensional nozzle speed and the actual nozzle speed.

Another exemplary embodiment of a three-dimensional printing system includes both a controller and one or more nozzles. The controller is configured to select a printing mode based on at least one of a non-dimensional nozzle speed and a non-dimensional nozzle tip height. The non-dimensional nozzle speed is based on both a nozzle speed and an extrusion speed, and the non-dimensional nozzle tip height is based on both a die-swollen diameter of material to be extruded from a nozzle and a combination of a height of a substrate configured to receive extruded material from the nozzle and a height of material disposed on the substrate. The one or more nozzles are for depositing material based on a print mode selected by the controller.

The controller can be configured to select a print mode from a plurality of print modes, the plurality of print modes including: accumulation, translating coiling, alternating coiling, stretching coiling, meandering, die-swelling, equi-dimensional, thinning, and discontinuous, among others. Alternatively, or additionally, the controller can be configured such that it selects values of at least one of the non-dimensional nozzle speed and the non-dimensional nozzle tip height based on at least one of the following properties of the material to be deposited from the nozzle: a deformation of the material, an instability of the material, and/or a fracture of the material. The one or more nozzles can be configured to deposit a viscoelastic ink based on a print mode selected by the controller. In some embodiments, the system includes a viscoelastic ink, with the viscoelastic ink being configured to be deposited by the one or more nozzles.

In some embodiments, the controller can be configured to generate a phase diagram for material to be printed from the one or more nozzles. The phase diagram can include a plurality of printing modes from which the printing mode is selected. The phase diagram can be based on the non-dimensional nozzle speed and the non-dimensional nozzle tip height of at least one nozzle of the one or more nozzles. The non-dimensional nozzle speed can be based on both a nozzle speed and an extrusion speed, and the non-dimensional nozzle tip height can be based on both a die-swollen diameter of material to be extruded from the at least one nozzle and a combination of a height of a substrate configured to receive extruded material from the at least one nozzle and a height of material disposed on the substrate. At least one printing mode can be based on a ratio that includes the non-dimensional nozzle speed and the non-dimensional nozzle tip. Additionally, or alternatively, at least one printing mode can be based on a comparison between the non-dimensional nozzle speed and a die-swelling ratio. Still further additionally, or alternatively, at least one printing mode can be based on a comparison between the non-dimensional nozzle speed and the actual nozzle speed.

### BRIEF DESCRIPTION OF DRAWINGS

This disclosure will be more fully understood from the following detailed description taken in conjunction with the accompanying drawings, in which:

FIG. 1A is a perspective view of one exemplary embodiment of a direct ink writing 3D printing system;

FIG. 1B is a schematic, cross-sectional side view of one exemplary embodiment of a nozzle for use in direct ink writing 3D printing systems and methods;

FIG. 1C is a schematic, cross-sectional side view of the nozzle of FIG. 1B being used to extrude a viscoelastic ink out of it to form a printed fiber;

FIG. 1D is a schematic, side view illustration of printed fibers having various printing modes that can be achieved using the single nozzle of FIG. 1B in accordance with the present disclosures;

FIG. 2A is a graph illustrating a storage modulus and a loss modulus of a viscoelastic ink as a function of angular frequency;

FIG. 2B is a graph illustrating a steady-state viscosity of the viscoelastic ink of FIG. 2A as a function of shear strain rate;

FIG. 2C is a graph illustrating the storage modulus of the viscoelastic ink of FIG. 2A as a function of shear stress;

FIG. 3A is a graph illustrating a ratio of an inner diameter of a nozzle from which a viscoelastic ink is extruded and a diameter of the viscoelastic ink after being extruded from the nozzle as a function of a ratio of a height from which the viscoelastic ink is extruded from the nozzle above a receiving surface and the inner diameter of the nozzle;

FIG. 3B is schematic, cross-sectional side view of a nozzle for use in direct ink writing 3D printing systems and methods, the nozzle being illustrated in use to provide steady coiling of a viscoelastic ink;

FIG. 3C is a schematic, top view of the viscoelastic ink of FIG. 3B being printed as a plurality of coils;

FIG. 4A is a plurality of time-lapse images taken while extruding a viscoelastic ink from a nozzle to form a printed fiber, the images illustrating a stretching region of the printed fiber;

FIG. 4B is a schematic, cross-sectional side view of a nozzle for use in direct ink writing 3D printing systems and methods, the nozzle being used to extrude a viscoelastic ink out of it to form a printed fiber, the printed fiber having a stretching region;

FIG. 4C is a graph illustrating a stretching angle formed by the printed fiber of FIG. 4B and a surface on which the printed fiber is being deposited as a function of a dimensionless parameter V* of the printed fiber for various fibers having a dimensionless parameter H*;

FIG. 5A is a plurality of time-lapse images taken while extruding a viscoelastic ink from a nozzle to form a printed fiber, the images illustrating fracture of the printed fiber;

FIG. 5B is a graph illustrating a dimensionless parameter V* of the printed fiber measured from an onset of fracture failure as a function of a dimensionless parameter H* of the printed fiber;

FIG. 5C is a graph illustrating a true strain rate of the printed fiber of FIG. 5B as a function of true strain at fracture for the printed fiber of FIG. 5B;

FIG. 6 is one exemplary embodiment of a phase diagram for use in conjunction with the direct writing ink 3D printing systems and methods provided for herein;

FIG. 7A is a chart illustrating experimental data for various values of dimensionless parameters V* and H* of a printed fiber, the results in each cell being the resulting configuration of the printed fiber based on the values of the dimensionless parameters;

FIG. 7B is a graph in which the experimental data of FIG. 7A is plotted in a phase diagram;

FIG. 7C is a graph illustrating a ratio of an inner diameter of a nozzle used to extrude viscoelastic ink to form the printer fibers of FIG. 7A and a diameter of the printed fibers after the viscoelastic ink is extruded from the nozzle as a function of the dimensionless parameter V*, with the dimensionless parameter H* being kept at a steady value;

FIG. 8A is another exemplary embodiment of a phase diagram for use in conjunction with the direct writing ink 3D printing systems and methods provided for herein;

FIG. 8B is a schematic, side view illustration of printed fibers having various printing modes that can be achieved using a single nozzle in view of the phase diagram of FIG. 8A;

FIG. 8C is a schematic, side view illustration of a single fiber extruded using a single nozzle, the fiber having various configurations achieved by the various printing modes in view of the phase diagram of FIG. 8A;

FIG. 9A is a schematic, side perspective view of a single nozzle being used to print one exemplary embodiment of a three-dimensional structure in continuous printing sequences, the three-dimensional structure having a plurality of layers, with various layers having been printed using different printing modes;

FIG. 9B is a schematic, side perspective view of a single nozzle being used to print another exemplary embodiment of a three-dimensional structure using continuous single nozzle printing, the resulting structure being a solid, three-layered structure with different fiber diameters at each layer, and the layers having been printed using different printing modes;

FIG. 10 a schematic, side view illustration of printed fibers having various printing modes that can be achieved using a single nozzle in view of a phase diagram, the nozzle printing a hydrogel ink to form the printed fibers;

FIG. 11A is a graph illustrating a locking stretch of a printed fiber as a function of the inverse of a dimensionless parameter V* of the printed fiber under simple tension;

FIG. 11B is a graph illustrating a force F applied to a direct writing ink 3D printed mesh formed by the printed fiber of FIG. 11A as a function of the stretch for the direct writing ink 3D printed mesh with meandering pattern in both X and Y directions;

FIG. 11C is a graph illustrating the force F applied to a direct writing ink 3D printed mesh formed by the printed fiber of FIG. 11A as a function of the stretch for the direct writing ink 3D printed mesh with meandering pattern in only the Y direction;

FIG. 11D is a top view of one exemplary embodiment of a direct writing ink 3D printed gradient mesh having various fiber diameters within the same layer;

FIG. 11E is a perspective view of one exemplary embodiment of a direct writing ink 3D printed gradient structure having varying fiber diameters over different layers;

FIG. 11F is a schematic illustration of another exemplary embodiment of a direct writing ink 3D printed gradient structure, the illustration demonstrating swelling of the structure;

FIG. 11G is a time lapse illustration of one exemplary embodiment of a direct writing ink 3D printed gradient actuator of direct writing ink 3D printed gradient structure, the time lapse illustration demonstrating an inhomogeneous swelling response of the gradient actuator in an organic solvent;

FIG. 12 is a graph illustrating a nominal stress applied to fibers printed in accordance with the present disclosures as a function of stretch of the printed fibers under tension;

FIG. 13 is a schematic illustration of one exemplary embodiment of printing multiple layers of fibers in accordance with the present disclosures, with different printing modes being used in the different layers; and

FIG. 14 is a graph illustrating an equilibrium swelling time of a printed fiber as a function of a diameter of the printed fiber in solvent.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Further, in the present disclosure, like-numbered components of various embodiments generally have similar features when those components are of a similar nature and/or serve a similar purpose.

The present disclosure provides systems and methods for using producing a three-dimensional structure having varied printed fiber configurations generated by a single nozzle in a continuous manner, without having to adjust the hardware of the system during the printing process. The systems and methods harness deformation, instability, and fracture of viscoelastic materials to adjust dimensionless parameters related to a speed of extrusion (e.g., the speed of the nozzle and the speed at which the material is deposited out of the nozzle), referred to herein as the dimensionless parameter V*, and a height of a nozzle with respect to a surface or material onto which the material is being deposited, referred to herein as the dimensionless parameters H*, to alter the printed fiber configurations. A phase diagram can be used to help outline the impact the dimensionless parameters on the resulting printed fiber configurations. The printed fiber configurations described herein include, but are not limited to: accumulation, translating coiling, alternating coiling, stretching coiling, meandering, die-swelling, equi-dimensional, thinning, and discontinuous, among other possible printing modes.

The present disclosure allows for highly tunable and repeatable printing, and also permits the ability to print stretchable structures with tunable stiffening and 3D structures with gradient properties and programmable swelling properties. All of these results can be achieved using a single nozzle, although multiple nozzles can be used to increase throughput. As a result, new printing strategies and formations can be achieved in direct image writing 3D printing, which can be applied across many different industries.

Direct Ink Writing Printing Devices and Systems

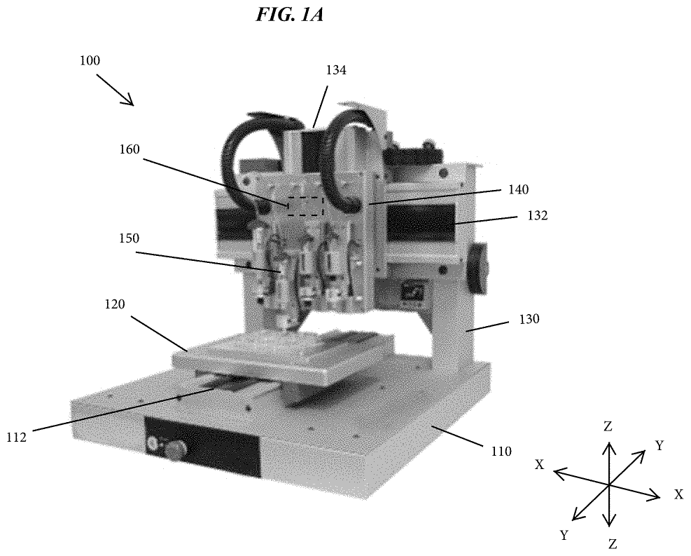

Direct ink writing (DIW) three-dimensional (3D) printing devices and systems come in a variety of configurations. The present disclosures allow for existing DIW printing devices and systems to be modified to operate in an improved manner, and the present disclosures also allow for newly configured DIW printing devices and systems. FIG. 1A provides for one, non-limiting example of a DIW 3D printing system 100 that can be used in conjunction with the teachings of the present disclosures. The illustrated printing system 100 is primarily for illustrative purposes to demonstrate a system in which a nozzle is provided for performing DIW 3D printing.

As shown, the DIW 3D printing system 100, also referred to as a printer, printing device, or device, includes a base 110, a receiving plate 120, a printhead support 130, a printhead 140, and a controller 160. The base 110 provides support for the receiving plate 120, and includes one or more tracks 112 along which the receiving plate 120 can be moved. In the illustrated embodiment, the track 112 allows for movement of the plate 120 along an illustrated Y-axis. Other tracks can be provided to allow movement of the plate 120 along an illustrated X-axis and/or an illustrate Z-axis. Further, movement of the plate 120 is not limited to along straight axes, as in other embodiments the system 100 can be configured to allow for 360° movement of the plate 120 with respect to the base 110 along and between any of the X, Y, and Z axes. A person skilled in the art will recognize many ways by which the plate 120 can be actuated to move along the track 112 (e.g., use of one or more motors, and/or other mechanical, electro-mechanical, or electrical systems), and thus a further description of how movement of the plate 120 with respect to the base 110 is implemented is unnecessary.

In addition to being configured to be moved with respect to the base 110, the receiving plate 120 can be configured to receive one or more printed fibers from the printhead 140. In some embodiments the plate 120 may include a designated print area. That print area can be the entirety of the plate 120, or some subpart thereof. The designated print area can be demarcated in some fashion, such as with a different color or by forming a raised or lowered surface around a perimeter of the print area, and can include other features that help define a print area. In some embodiments, a surface of the receiving plate 120 can be treated to allow it to be conducive to maintaining a location of a printed fiber, while also allowing the printed fiber to be separated from the receiving plate 120 in an easy manner so as not to harm the printer object when it is completed and ready to be removed from the receiving plate 120. In some embodiments, the plate 120 comprises a substrate, and it can wholly be a substrate.

The printhead support 130 is a structure that is disposed in a manner that is substantially perpendicular to the base 110 (and thus the receiving plate 120 in the illustrated embodiment). Other configurations between the support 130 and the base 110 are certainly possible without departing from the spirit of the present disclosure. As shown, the support 130 includes a track 132 that allows for movement of the printhead 140 along the illustrated X-axis. Further, because the printhead support 130 extends vertically above the base 110, the printhead 140 is also located a distance above the base 110, i.e., along the illustrated Z-axis. Still further, the illustrated embodiment provides for a second track 134 that allows for movement of the printhead 140 along the illustrated Z-axis. Like with the illustrated movement of the plate 120 along the X-axis, movement of the printhead 140 is not limited to movement along one or more of the axes, as in alternative configurations movement can be in more of a freeform manner (i.e., not restricted to a track) such that it can have 360° of movement with respect to any of the base 110, the plate 120, and/or the support 130. Further, a person skilled in the art will recognize many ways by which the printhead 140 can be actuated to move along the tracks 132, 134 (e.g., use of one or more motors, and/or other mechanical, electro-mechanical, or electrical systems), and thus a further description of how movement of the printhead 140 with respect to any of the base 110, the plate 120, and/or the support 130 is implemented is unnecessary.

The printhead 140 can include one or more nozzles 150 for ejecting material towards the receiving plate 120 to produce one or more fibers for use in constructing, i.e., printing, a three-dimensional object. In the illustrated embodiment, there are four nozzles 150, each extending in a row along the illustrated X-axis. In other embodiments, one or more nozzles can extend along other axes, or anywhere on the printhead 140, even if not along one of the illustrated axes. For example, a second row of nozzles can be provided along the X-axis, but a distance further along the Y-axis from the support 130. The nozzles 150 can be integrally formed with respect to the printhead 140, or they can be removable and replaceable, thereby allowing different nozzle configurations to be used. In some embodiments, the nozzles 150 can be configured to move along the illustrated Z-axis, in addition to or in lieu of the printhead 140 moving along the Z-axis in view of the track 134. A person skilled in the art will recognize how printheads and nozzles are generally constructed and operated, and thus additional details about their structure and function, apart from the highlighted features described below, are unnecessary.

Notably, although the illustrated embodiment provides for a plurality of nozzles 150, one feature of the present disclosure is the fact that a single nozzle can be operated to achieve different configurations of printed fibers in a continuous manner, without modifying the nozzle itself or using other nozzles. Accordingly, a system 100 that utilizes a single nozzle can perform the functions provided for herein. When a printing system in accordance with the present disclosure includes multiple nozzles, it can allow for quicker, more diverse printing because one or more of those nozzles, including all of those nozzles, can be operable in accordance with the present disclosures to allow for different configurations of printed fibers to be printed in a continuous manner, without modifying the nozzles or using the surrounding nozzles to create the different configurations. The illustration of a system having multiple nozzles is in no way limiting, and thus a system including a single nozzle is likewise a preferred embodiment, as is a system having multiple nozzles. There is no real upper limit to the number of nozzles that can be part of a printing system where the nozzles incorporate the printing techniques disclosed herein. Further, to the extent the descriptions below are described as being applied to a single nozzle, a person skilled in the art will recognize the descriptions can be applied to a plurality of nozzles. For example, more than one nozzle can be moved at particular speeds (e.g., the speed V), can extrude material at a particular speed (e.g., the speed C), and/or can be raised or lowered to particular heights (e.g., the height H) simultaneously, allowing for quicker manufacture of a part having identical printed fiber locations in at least some portions of the object being printed.

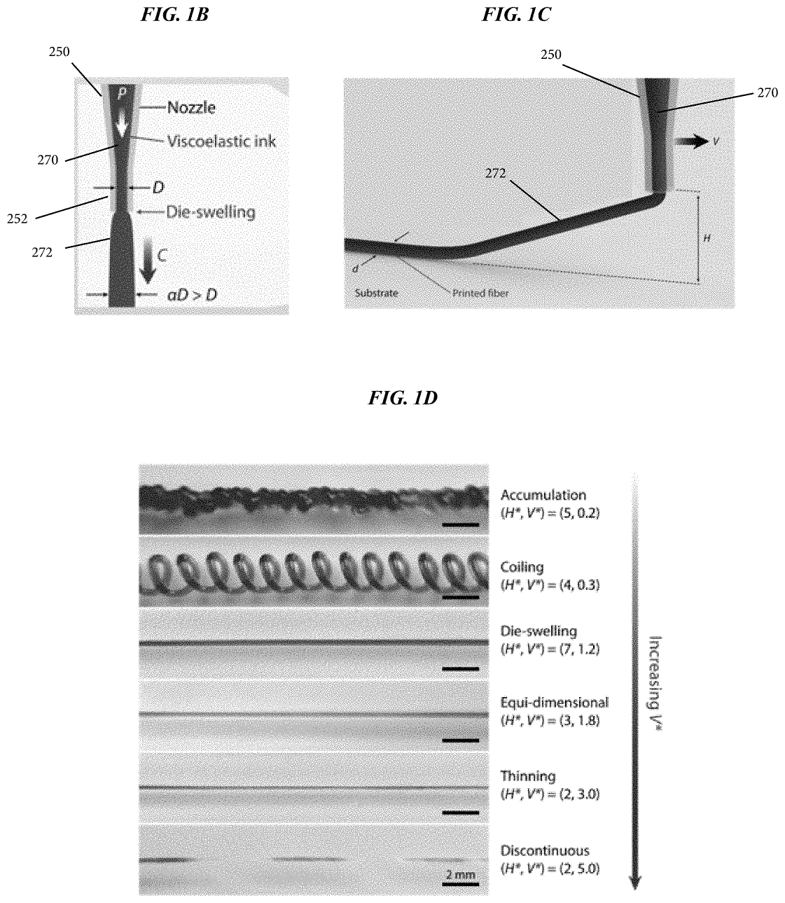

The nozzle(s) 150 can be used to extrude, or otherwise deposit, a material onto the receiving plate 120. This material can be a viscoelastic ink, which is a material having both viscous and elastic properties. Viscoelastic inks can have a variety of make-ups or configurations, and in some embodiments the inks can have at least one of a polymer base, a nano-particle filler, or a micro-particle filler. Viscoelastic inks can exhibit characteristic responses during flow or injection for printing such as shear yield-stress and/or shear thinning. FIG. 2B, described further below, provides typical shear thinning response of viscoelastic inks, in which higher shear rates (or higher rates of injection) gives lower viscosity. FIG. 2C, also described further below, provides typical shear yield stress response of viscoelastic inks, in which the viscoelastic ink undergoes transition between solid-like state to fluid-like state as the shear stress of flow or injection increases.

The controller 160 helps to operate components of the system 100, such as the printhead 140 and/or plate 120, by providing printing commands to one or more components of the system 100. The printing commands can include any command related to the operation of system 100, including but not limited to: commands that cause the printhead 140 to move with respect to the base 110, the plate 120, and the support 130; commands related to extrusion of material from the nozzle(s) 150, such as controlling parameters like the speed C at which the extrusion occurs, a speed V at which the nozzle(s) 150 moves (and thus the dimensionless parameter V*, which is a function of the speed V and the speed C, as described below), and a height H of the nozzle(s) 150 with respect to the surface onto which the extruded material is being printed (e.g., the receiving plate 120 and/or one or more previously printed layers of printed fibers) (and thus the dimensionless parameter H*, which is a function of the height H, among other parameters, as described below); and/or commands related to other components of the system to allow movement with respect to the printhead 140, such as commands to move the plate 120 along the track 112). Thus, it is the controller 160, or a person or machine operating the controller 160, that can change the parameters to provide various printing modes, such parameters and printing modes being described in greater detail below. The controller 160, or person or machine operating the controller 160, can more generally select a desired printing mode(s), and the controller 160 can then implement changes to one or more parameters to achieve the desired printing mode(s). A person skilled in the art will understand many different commands that can be controlled or otherwise implemented by the controller 160 in view of the present disclosures.

In the embodiment provided for in FIG. 1A, the controller 160 is illustrated by phantom lines as an internal part of the printhead 140. The controller 160, however, can be disposed or otherwise associated with the system 100 in any number of ways. The controller 160 can be part of one or more of the components of the system 100 (e.g., part of the printhead 140 as shown, part of the support 130, part of the base 110, part of the receiving plate 120, etc.), or it can be its own separate component that is communication with one or more of the base 110, receiving plate 120, support 130, printhead 140, nozzle(s) 150, or components thereof, to allow for operation of the same. In some embodiments, the controller 160 can be a computer or smart device, or a part thereof, that provides the commands to the system 100 at a location remote from the system 100 itself. Notably, the controller is configured in a manner that allows for a variety of different printing modes to be achieved without changing hardware of the system. For example, in view of the present disclosures, no modifications to a printhead or nozzle are needed to allow for printing modes that achieve: accumulation, translating coiling, alternating coiling, stretching coiling, meandering, die-swelling, equi-dimensional, thinning, and discontinuous, among other possible printing modes. The controller can operate such printing modes in a continuous manner such that multiple modes can be achieved during extrusion of the same fiber. The capabilities of the controller will become clearer as the printing techniques are described in greater detail below.

A person skilled in the art will appreciate may different sizes, shapes, and materials can be used to make the various components of the DIW 3D printing system 100. For example, although in the illustrated embodiment the base 110 and the plate 120 are substantially rectangular in shape, a variety of shapes (e.g., circular, triangular, trapezoidal, other polygons) can be used in conjunction with the base 110 and the plate 120. The shapes of the various components do not have to be the same either, so the base 110 can be rectangular while the receiving plate 120 can be hexagonal. Standard materials can be used to make any of the various components of the DIW 3D printing system 100. For example, a stainless steel or titanium alloy, among other materials, can be used to form components like the base 110, plate 120, and printhead support 130. A person skilled in the art will recognize such suitable materials for the various components, and thus additional descriptions of the same is unnecessary.

Although FIG. 1A provides for one embodiment of a DIW 3D printing system, a person skilled in the art will appreciate that the illustrated system can be modified in many different manners, including to add features (e.g., additional tracks or the like to provide for additional movement capabilities) and remove or modify features (e.g., remove the printhead support 130 and provide an alternative way by which the printhead 140 can move with respect to the receiving plate 120 and/or the base 110). Likewise, a person skilled in the art will appreciate many other configurations of DIW 3D printing systems can be used to move one or more nozzles with respect to a receiving plate, whether those nozzle(s) is part of a printhead or separately disposed as a nozzle(s).

Nozzle(s)

FIG. 1B provides for a detailed view one exemplary embodiment of a nozzle 250 for use in conjunction with present disclosures. The illustrated embodiment is used to demonstrate some of the limitations of existing DIW printing techniques, but the illustrated embodiment can be used to implement the present disclosures to allow for improved DIW 3D printing. As shown, the nozzle 250 has a tapered distal end 250d leading to a tip 252. A viscoelastic ink 270 can be extruded out of the tip 252, with an inner diameter of the tip 252 being illustrated as the inner diameter D. Extrusion of the ink 270, out of the tip 252, can be achieved using any technique known to those skilled in the art for extruding a material from a location, including but not limited to operating a screw or piston (not shown) to apply a force to the ink 270 disposed in the nozzle 250, with the resulting pressure advancing the ink 270 out of the nozzle 250, through the tip 252, and onto a receiving surface. The extrusion can occur at a speed C, and can be achieved without deformation of the ink. As shown, using existing techniques, extrusion of viscoelastic inks can lead to die-swelling of the inks, which results in printed fibers 272 with a diameter αD, where α is a die-swelling ratio greater than unity. Accordingly, the extrusion rate (or feed rate) Q due to the volume conservation is:

Q=πC(αD)²/4. (1)

The nozzle tip can move at a speed of V and a height of H (from the surface of the plate 120 or printed layers disposed on the plate 120) while depositing fibers of the viscoelastic ink. In conventional DIW 3D printing, the moving speed of the printer nozzle V is set to be equal to C. As a result, the resolution of printed fibers is limited to αD, and the printed pattern is controlled by the continuous motion path of the nozzle 250. A person skilled in the art will recognize that a value of C is typically determined by material properties of the ink and applied pressure P during DIW 3D printing.

Distinct from conventional DIW 3D printing, the systems and methods provided for herein allow a single nozzle to print fibers with various diameters much smaller than αD, significantly enhancing the resolution of DIW printing. Further, the systems and methods provided for herein allow for a printed fiber that can be discontinuous despite providing for continuous motion of the nozzle. Still further, the systems and methods provided for herein allow for the creation of complex patterns of printed fibers that can be achieved with simple straight nozzle motions.

Non-Dimensionalized Printing Parameters

As provided for herein, it is possible to control two non-dimensionalized printing parameters to achieve the desired results of improved DIW 3D printing systems and methods. The two non-dimensionalized printing parameters are:

$$\begin{matrix}{V}^{*} ≡ \frac{V}{C} & ( 2 a ) \\ {H}^{*} ≡ \frac{H}{α D} & ( 2 b )\end{matrix}$$

with V* representing the non-dimensional nozzle speed and H* representing the non-dimensionalized nozzle tip height. In conventional DIW 3D printing, the printing parameters V* and H* are commonly set to be unity so that the extruded viscoelastic ink is deposited without significant deformation. The present disclosure, on the other hand, tunes at least one of V* and H* to exploit deformation, instability, and fracture of viscoelastic inks. Such tuning can occur across wide value ranges, and the tuning can enable new modes of DIW 3D printing, which include accumulation, coiling, die-swelling, equi-dimensional, thinning, and discontinuous modes (see FIG. 1D), described and illustrated further below.

FIG. 1C illustrates the nozzle 250 being moved at a speed V and raised a height H above a surface (e.g., a surface of a receiving plate, like the receiving plate 120, or previously printed material on the receiving plate). The printed fiber 272, which is formed by the extruded material 270, can have a diameter d that is steady and consistent without die-swelling in view of the present disclosures. Many different configurations of printed fibers are possible, including but not limited to continuous and discontinuous fibers with diameters much finer than nozzle diameter (e.g., thinning and discontinuous modes), and non-linear complex patterns of the fibers (e.g., coiling and accumulation modes) with a single nozzle. By controlling one or both of the printing parameters V* and H* in a reproducible and predictable manner, various fiber configurations, some of which are illustrated in FIG. 1D, can be produced in an accurate, reliable, reproducible, and predictable manner.

More particularly, FIG. 1D provides for non-limiting exemplary values that can be used for the printing parameters V* and H* to produce various fiber configurations. As shown, the various configurations are illustrated with an increasing value of V*, although in other instances, it is the parameter H* that can be consistently increased or decreased to achieve particular results. The illustrated modes include: accumulation, coiling, die-swelling, equi-dimensional, thinning, and discontinuous. Other printing modes provided for herein, or otherwise derivable from the present disclosures, are possible. A person skilled in the art, in view of the present disclosures, will understand how to modify the printing parameters V* and H* to produce desired fiber configurations. Unlike previous iterations of DIW printing, the printed fibers have a resolution unlimited by the nozzle diameter, and the production of such fibers can be achieved in a highly controllable manner.

Exturded Material, Including Viscoelastic Inks, and the Formation of Printed Fibers

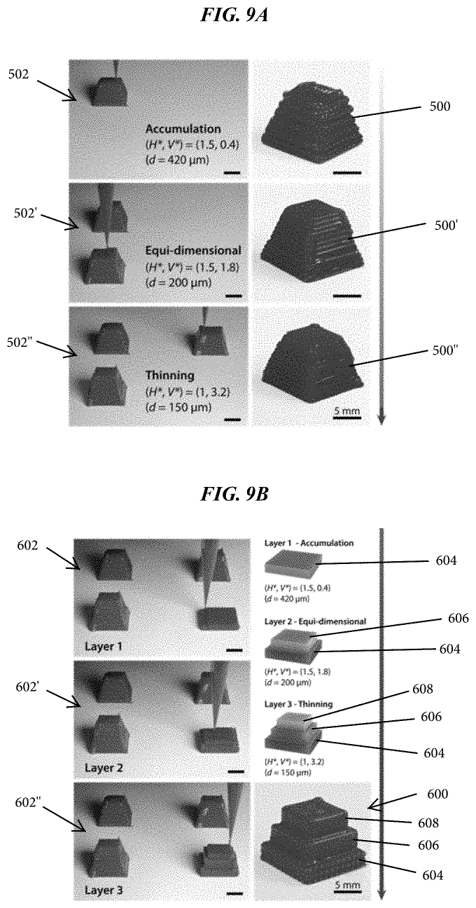

As discussed above, a variety of viscoelastic inks can be employed in conjunction with the present disclosures. The mechanics of viscoelastic inks help to achieve the very benefits described herein. This is due, at least in part, to their properties, including their viscoelasticity, shear thinning, and yield stress flow. Properties of the material more generally, including a deformation of the material, an instability of the material, and a fracture of the material, can impact the resulting printed fiber. Accordingly, the system (e.g., the system 100), via components such as a controller (e.g., the controller 160) and/or an operator of the system, can be configured to select values of various parameters based on the properties of the material being extruded. A person skilled in the art, in view of the present disclosures, will recognize that the values of the dimensionless parameters H*, V* can vary depending on the material used, among other factors that may impact the parameter values. The boundaries for the various modes depend, at least in part, on the material of the property, among other factors discussed herein or otherwise understood by a person skilled in the art in view of the present disclosures. For example, as illustrated in FIG. 10, different values of V* (0.3, 0.6, 0.8, 1.5, 3, 10, 25, and 30) for H*=4 can be selected to print several lines with straight nozzle motions for a hydrogel ink (e.g., PEO solution), with these values being different than those described earlier. To the extent coiled patterns have been adopted for use in previous DIW 3D printing systems and methods, no such systems and methods can achieve the fine resolutions afforded by the present disclosures, i.e., resolutions that are significantly finer than the nozzle diameter (e.g., up to about 1.9 times and about 5.4 times for the silicone elastomer and the hydrogel inks, respectively). Likewise, to the extent coiled patterns have been adopted for use in previous DIW 3D printing systems and methods, no such systems and methods can achieve discontinuous patterns in a highly predictable and reproducible manner by following a quantitative phase diagram and/or by achieving different fiber configurations across a single, continuous fiber without modifying the nozzle.

FIGS. 2A-2C illustrate some of the rheological characteristics of viscoelastic inks, with the data having been collected for room temperature (25° C.). FIG. 2A provides for a plot of a storage modulus G′ and a loss modulus G″ as a function of angular frequency ω. The storage modulus G′ represents elastic property of the ink while the loss modulus G″ represents viscous property of the ink. Viscoelastic inks typically exhibit complex profile of G′ and G″ in different shear rates (or rates of injection) represented as angular frequency ω. FIG. 2B provides a plot of apparent steady-state viscosity η as a function of shear strain rate \dot{γ}. As shown, the viscoelastic ink exhibits a shear-thinning. FIG. 2C provides a plot of G′ as a function of shear stress τ. As shown, the viscoelastic ink exhibits a yield stress flow.

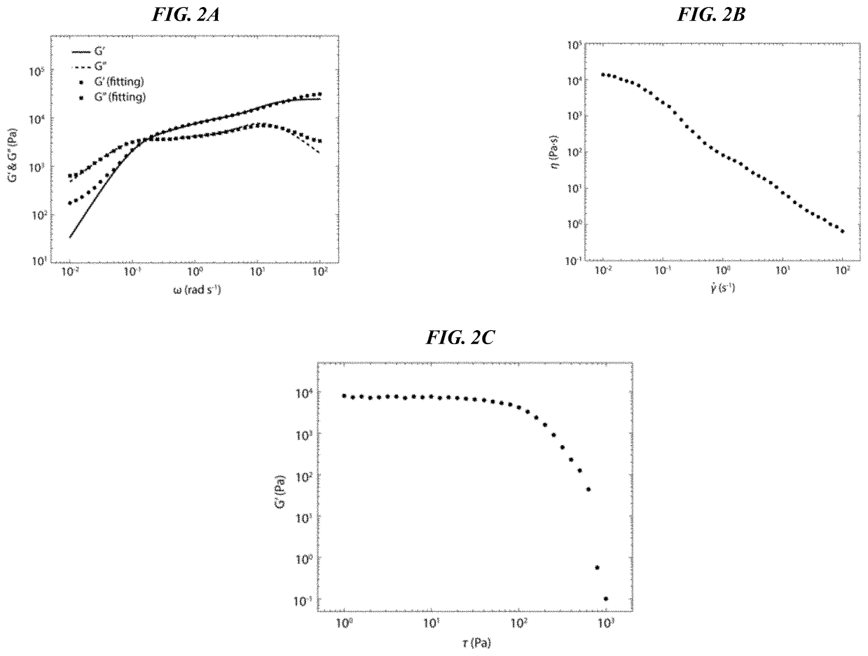

FIG. 3A provides for a plot of a ratio of a diameter of an extruded material (d) and an inner diameter of a nozzle (D) as a function of a ratio of a height of the nozzle from a surface onto which the material is being deposited (H) and the inner diameter of the nozzle (D). The results for experiments involving four different nozzles sizes are provided: 400 μm, 200 μm, 100 μm, and 50 μm, with the dots representing experimental data, and the dotted lines representing corresponding die-swelling ratios α for each nozzle.

As illustrated in FIGS. 2A-2C and 3A, the effects of gravitational stretching and inertia are negligible. Under such conditions, it has been shown that coiling instability typically occurs when V≤U_{c}, where U_{c} is the steady coiling speed defined as U_{c}≡R_{c}Ω_{c} with R_{c} the radius of steady coiling and Ω_{c} the angular speed of the steady coiling. This is illustrated in FIG. 3B, in which a viscoelastic ink 370 being deposited from a nozzle 350 to form a fiber 372 becomes coiled. In view of the present disclosures, steady coiling can be achieved from a single nozzle, and such coiling can occur across different fiber diameters and in different coiling patterns (e.g., translating, alternating, stretching, meandering). Notably, the negligible gravitation stretching renders that the speed of ink extrusion is identical to the steady coiling velocity, U_{c}=C. This provides the printed fiber diameter in coiling instability as d=αD. Thus, the condition of coiling instability is V≤C, which renders V*≤1, given that H* is large enough to avoid accumulation of the printed ink. The geometric model of coiling instability also provides the corresponding ranges of V* for each sub-mode of printing: translating coiling (0<V*<0.33); alternating coiling (0.28<V*<0.6); stretching coiling (0.55<V*<0.68); and meandering (0.53<V*<1).

As provided for herein, a controller (e.g., the controller 160) can alter the various parameters of the dimensionless parameters V* and H* to achieve various printing modes. Any of the variables that correlate to such parameters can be altered by the controller. Accordingly, while it may be more conventional and/or easy to alter the height H of the dimensionless parameter H*, in some embodiments a system can be configured such that the controller, or another component associated with the controller, can alter either or both of the die-swelling ratio α of the material and the inner diameter D of the nozzle to provide for a different value of the dimensionless parameter H*. For example, in some instances a nozzle may be configured such that its inner diameter D can be altered while in operation.

When the gravitation stretching is negligible, the radius of steady coiling can scale with the nozzle tip height, R_{c}˜H, and therefore, Ω_{c}˜C/H. With this relation, the translational movement of the nozzle during each cycle of coiling can be expressed as VΔt, where Δt˜1/Ω_{c}. As shown in FIG. 3C, the coiled fibers overlap each other when the translational movement is smaller than the printed fiber diameter, VΔt≤αD, resulting in merging between the printed fibers and accumulation of the deposited ink. Thus, the condition of the accumulation mode of printing can be expressed as:

$${V}^{*} \leq \frac{1}{{H}^{*}} \qquad ( 3 )$$

where the diameter of printed fiber d=αD/\sqrt{V*} calculated from the volume conservation of the extruded ink) can be much greater than nozzle inner diameter D due to the accumulation of ink.

Because the boundary between accumulation and coiling mode is given as V*=1/H*, the complete condition for the coiling mode of printing becomes:

$$\frac{1}{{H}^{*}} < {V}^{*} \leq 1 \qquad ( 4 )$$

where the diameter of printed fiber d is equal to the die-swollen diameter αD. The coiling mode generally requires H*>1 because the deposited ink is typically squeezed between the nozzle tip and the substrate or printed layers when H*≤1.

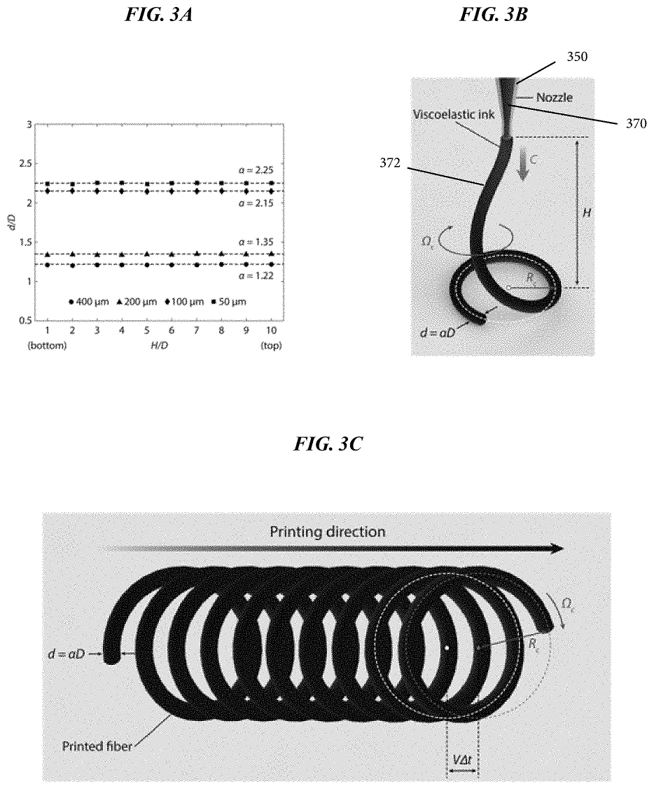

When V*>1, the extruded viscoelastic ink can start to get stretched due to the motion of the nozzle, as illustrated in FIG. 4A by way of time-lapse images. As shown, the stretched viscoelastic ink by the motion of the nozzle eventually touches the substrate and resides to form a resultant stable printed structure. FIG. 4B schematically illustrates the stretching mode of printing with corresponding geometric parameters. As shown, a nozzle 450 extrudes a viscoelastic ink 470 to form a printer fiber 472. The geometric consideration and the volume conservation of the extruded ink 470, i.e., the fiber 472, provide that the stretch ratio is the same as V* with the stretching angle

$$θ = arccos ( \frac{{V}^{*} - 1}{{V}^{*}} ) ,$$

which agrees reasonably well with experimental data for H*=2, 4 and 6, which is illustrated in FIG. 4C. More particularly, FIG. 4C plots the stretching angle θ as a function of the dimensionless parameters V* and H*, with the dots representing experimental data when H* equals 2, 4, and 6, and the solid curve representing the prediction of this relationship in view of the experimental data. Moreover, the corresponding true strain ε and true strain rate \dot{ε} are ε=ln V* (with respect to the printed fiber length without stretching) and

$$\dot{ɛ} = \frac{C}{α D} \frac{1}{{H}^{*}} ln {V}^{*} ,$$

respectively. Assuming incompressibility and volume conservation of the extruded ink, the diameter of the printed fiber 472 can be calculated as d=αD/\sqrt{V*}. According to the normalized nozzle speed, the die-swelling mode can be classified as:

1<V*<α² (5)

where the die-swelling effect is dominant and the diameter of printed fiber d is greater than nozzle inner diameter D.

Further, according to the normalized nozzle speed, the equi-dimensional mode can be classified as:

V*=α² (6)

where the diameter of printed fiber d is equal to nozzle inner diameter D.

Still further, according to the normalized nozzle speed, the thinning mode can be classified as:

α²<V*<V*_{f} (7)

where the diameter of printed fiber d can be much smaller than nozzle inner diameter D, enhancing the resolution of the printing. In Equation (7), V*_{f} is the non-dimensional nozzle speed at which the extruded ink starts to undergo fracture. Hence, the upper limit of the thinning mode is given as V*=V*_{f}. It should be noted that V*_{f} is a material property, given that the Weissenberg number is greater than one. For example, the experimental measurements give V*_{f}≈3.5 for a silicone elastomer ink (e.g., SE 1700; Dow Corning and Dragon Skin; Smooth-On), and V*_{f}≈30 for a hydrogel ink (PEO solution). Accordingly, by adopting a thinning mode of printing, the resolution of the printed fibers can be enhanced up to about 1.9 times and about 5.4 times for the silicone elastomer and the hydrogel inks, respectively.

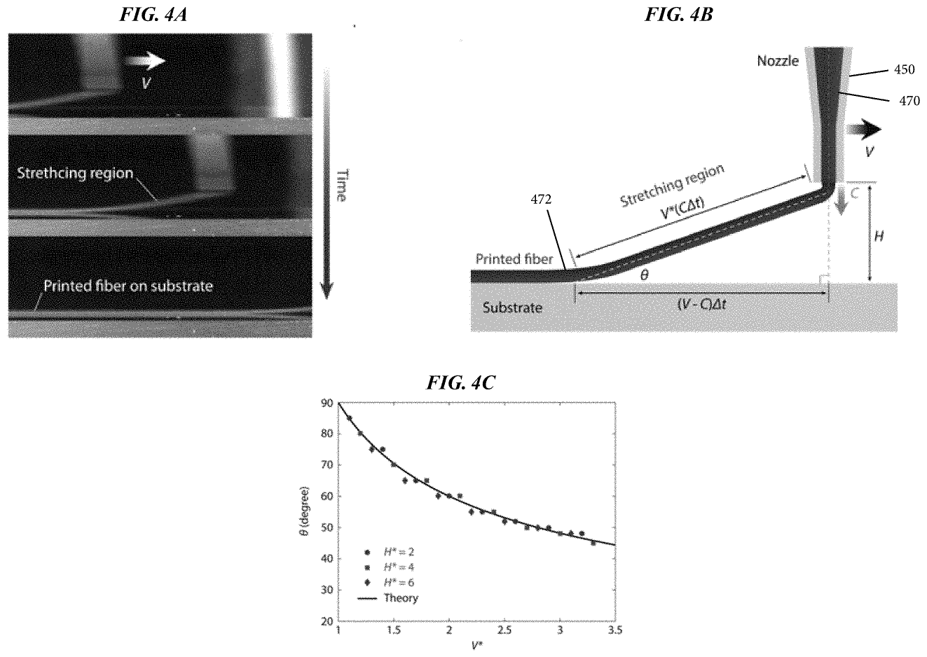

When the nozzle speed exceeds V*_{f}, the thinning of extruded ink by stretching transits to the fracture of stretched ink, resulting in discontinuous patterns of printed fiber segments, as illustrated in FIG. 5A by way of time-lapse images. As shown, the stretched viscoelastic ink by the motion of the nozzle undergoes fracture as the amount of stretching exceeds the elastic limits of the viscoelastic inks, and eventually touches the substrate and resides to form stable printed structure in discontinuous manner. Accordingly, the condition for the discontinuous mode of printing can be expressed as:

V*_{f}≤V* (8)

where the diameter of printed fiber d reaches its minimum value αD/\sqrt{V*_{f}} as the fiber cannot be further stretched. FIG. 5B provides for a plot of experimentally measured V* for the onset of fracture failure as a function of H*, with the dots representing experimental data, the dotted line representing a corresponding V*_{f}, and the solid line representing the values of V* above which the Weissenberg number (Wi) is greater than 1. FIG. 3 provides for a plot of true strain rate \dot{ε} as a function of true strain at fracture ε_{f}, with the dots again representing experimental data, the dotted line representing a corresponding ε_{f}, and the solid line representing the value of \dot{ε} above which the Weissenberg number (Wi) is greater than 1.

Phase Diagram

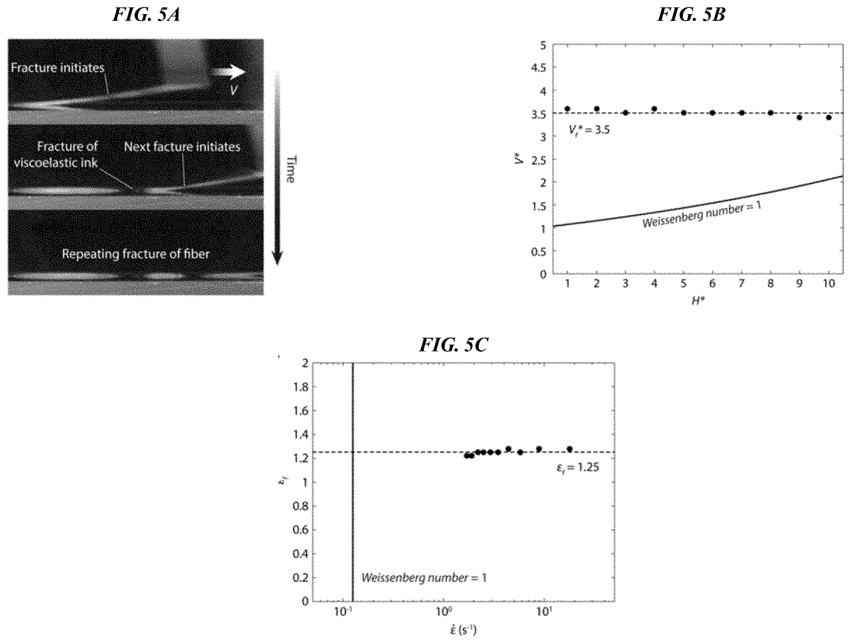

FIG. 6 illustrates a quantitative phase diagram of the various configurations of printed fibers that can be formed in view of the present disclosures. As discussed above, it is the non-dimensional printing parameters (H*, V*) that guide rational selection of parameters to achieve the various configurations, and this is reflected qualitatively in the phase diagram. The phase diagram helps establish which values of the non-dimensional printing parameters produce which printing modes. Phase diagrams will be different for different materials (e.g., different die-swelling ratios) and different nozzle configurations (e.g., different inner diameters), among other factors that will impact phase diagrams.

As shown, the dimensionless parameter V* is plotted on the Y-axis and the dimensionless parameter H* is plotted on the X-axis. Schematic illustrations of the various printing modes to clearly illustrate the configuration of the resulting printed fiber are provided at the right.

As shown, a discontinuous printing mode or configuration is achieved when V* is greater than or equal to approximately V_{f}*, where V_{f}* is the non-dimensional nozzle speed at which the extruded viscoelastic ink starts to undergo fracture, which is a material property of a specific viscoelastic ink. As V* becomes approximately less than V_{f}*, the printing mode can shift to a thinning printing mode or configuration. As shown, thinning occurs when V* is greater than or equal to approximately the square of the die-swelling ratio (α²), with V* being approximately less than V_{f}*. The printing mode or configuration becomes equi-dimensional when V* approximately equals α², and a die-swelling printing mode or configuration results when V* is approximately greater than or equal to 1 and less than approximately α².

In the illustrated phase diagram, various coiling configurations begin when V* is less than approximately 1. As shown, a meandering printing mode or configuration can occur when V* is greater than approximately 0.53 and less than approximately 1, a stretching coiling printing mode or configuration can occur when V* is greater than approximately 0.55 and less than approximately 0.68, an alternating coiling printing mode or configuration can occur when V* is greater than approximately 0.28 and less than approximately 0.6, and a translating coiling printing mode or configuration can occur when V* is greater than approximately 0 and less than approximately 0.33. Notably, there is overlap in these numbers for each mode, but each mode can also be assigned to unique narrower ranges without overlap. A person skilled in the art will recognize how various modes can be inter-mixed when transitioning from one more to the next by choosing appropriate combinations of V* and H* for each mode in view of the present disclosures. Finally, as shown, accumulation can result when the dimensionless parameter V* is less than or equal to the inverse of the dimensionless parameter H* (i.e., 1/H*). Further, as illustrated, coiling instability develops as the value for H* gets greater.

A person skilled in the art will recognize that the phase diagram of FIG. 6 is representative for one or more viscoelastic materials, but that other materials may have different phase diagrams. The creation of different phase diagrams for different parameters, and for other factors that impact a phase diagram (e.g., different nozzle sizes), is contemplated by, and made possible by, the present disclosure. A phase diagram like the one in FIG. 6 can be relied upon by the system (e.g., the system 100) to help control the parameters selected to achieve the desired results. More specifically a controller (e.g., the controller 160) can generate and/or use a phase diagram for material to be printed from a nozzle (e.g., the nozzle(s) 150) to form a 3D object. Changes to the printing modes can be made based on the phase diagram. Further, if conditions change during the printing process, the phase diagram can be updated in real time.

Experimental Validation of Printing Methods

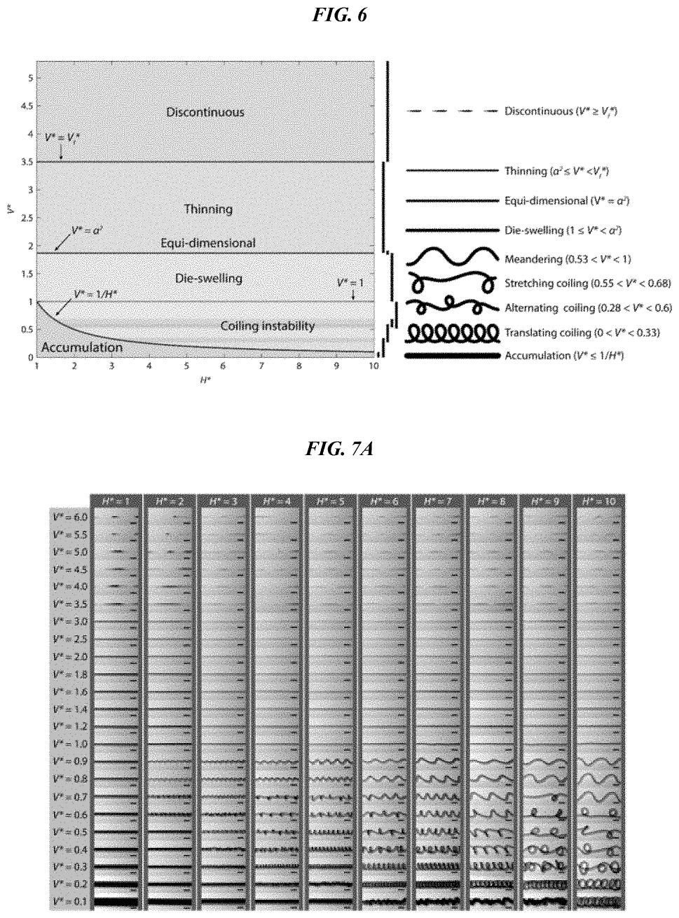

The use of the non-dimensional printing parameters (H*, V*) to achieve particular fiber configurations, and in particular the values of those parameters that can be used to achieve those parameters, were further validated by experimental testing. These experiments were performed using a systematic set of experiments for various combinations of H* and V* with a silicone elastomer ink (in the experiments, SE 1700; Dow Corning and Dragon Skin; Smooth-On). FIG. 7A shows the resulting printed fibers under different conditions of H* and V* (the illustrated scale bars are 2 millimeters), with the corresponding modes of printing summarized in FIG. 7B (e.g., accumulation, translating coiling, alternating coiling, stretching coiling, meandering, die-swelling, equi-dimensional, thinning, and discontinuous). As shown, the experimental data shows good agreement with the phase diagram. FIG. 7C plots the ratio of the diameter of the printed fiber (d) and the diameter of the inner diameter of the nozzle (D) as a function of the dimensionless parameters V* when the dimensionless parameter H* is maintained at approximately 5. The dots represent experimental data, and the solid line represents the theoretical prediction based on the phase diagram. As shown, the printed fiber diameter can be predicted reasonably well over various printing modes and parameters, further demonstrating the enhanced resolution of DIW printing in comparison to previous iterations of DIW printing.

Printing Methods with a Variety of Diameters

The systems and methods provided for herein can be used in conjunction with printing fibers of various diameters. This is because the present disclosures are not limited by nozzle diameter. Complex patterns with straight nozzle motions can be achieved with diameters of various thickness when the present teachings are utilized. Furthermore, the transition between different modes or configurations (e.g., translating coiling, stretching coiling, meandering, die-swelling, equi-dimensional, thinning, etc.) can be continuous, enabling the continuous printing of various non-linear patterns and fiber diameters by one nozzle in undisrupted manner.

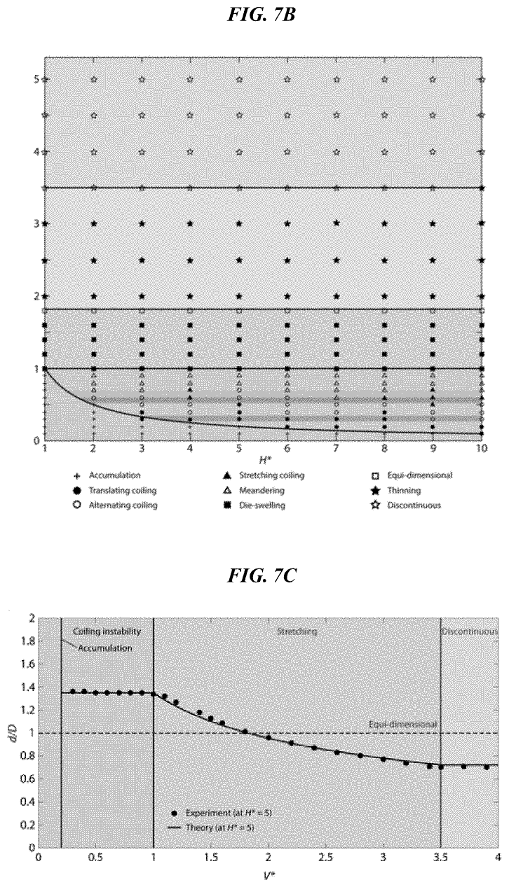

For example, as illustrated in FIG. 8A, parallel straight paths of the nozzle motion can be programmed with different values of V* (0.1, 0.4, 0.8, 1.1, 1.8, 2.5, and 5.0) and H*=5 for each path. More particularly, FIG. 8A provides a phase diagram with marked symbols (e.g., solid circle or star with number) for corresponding printing parameters selections. Just like with the phase diagram of FIG. 6, the phase diagram of FIG. 8A can be used to achieve various modes of printing, and their corresponding non-linear patterns and fiber diameters, and can be done so in a highly reproducible manner. This is demonstrated by FIG. 8B, in which accumulation, translating coiling, meandering, die-swelling, equi-dimensional, thinning, and discontinuous configurations are provided for various values of V*. Each printing condition corresponds to the solid circle symbols along the dotted line provided for in FIG. 8A.

FIG. 8C illustrates that the present disclosure allows for single nozzle printing of various non-linear patterns and fiber diameters in a single printed fiber by continuous transition between different modes. Each printing condition corresponds to the solid star symbols provided for in FIG. 8A. As shown, the speed and the height of the nozzle can be continuously varied across a printing path (as can the speed of the extrusion, among other factors). As shown, the variance for V* is from approximately 0.3 to approximately 2.5, and the variance for H* is from approximately 5 to approximately 2 along a straight motion path of the nozzle. The result is a continuous printing of the fiber across different modes (from coiling to thinning) in a single fiber without disrupting the printing process or the nozzle motion path. As shown, the fiber diameters can have varying diameters (from d is approximately 270 μm to approximately 170 μm) across the single continuous fiber.

Printing 3D Structures

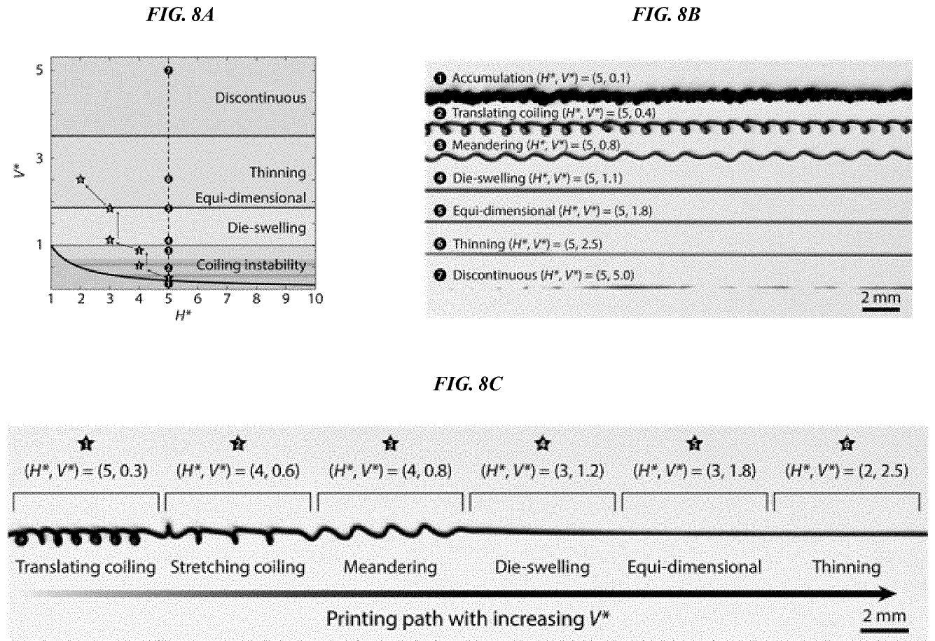

The capability of tuning fiber diameters in a highly reproducible and predictable manner allows for improved printing of three-dimensional objects or structures, including solid structures. The resulting structures can have varying resolutions and layer thickness using a single nozzle. FIGS. 9A and 9B illustrate exemplary pyramid structures that can be produced in accordance with the present disclosures, with FIG. 9A demonstrating the same printing modes across a plurality of layers to form structures, and FIG. 9B demonstrating the use of different printing modes across a plurality of layers to form structures.

As shown in FIG. 9A, a continuous single-nozzle printing sequence can be programmed to print full-filled, three-dimensional solid pyramids with different resolutions and layer thicknesses due to varying fiber diameters. In the illustrated embodiment, a first structure 500, as shown a pyramid formed by a plurality of printed layers, is formed using the accumulation printing mode 502 (e.g., d=approximately 420 μm with (H*, V*)=(approximately 1.5, approximately 0.4)) for each layer. A second structure 502′, again as shown a pyramid formed by a plurality of printed layers, is formed using the equi-dimensional mode 502′ (e.g., d=approximately 200 μm with (H*, V*)=(approximately 1.5, approximately 1.8)) for each layer. Further, a third structure 502″, again as shown a pyramid formed by a plurality of printed layers, is formed using the thinning mode 502″ (e.g., d=approximately 150 μm with (H*, V*)=(approximately 1, approximately 3.2)) for each layer.

FIG. 9B illustrates the ability for a single structure to include different layers being printed using different printing modes, with the layers being formed during a continuous printing process in which the hardware of the printer is not altered during printing (i.e., no nozzle is switched out during printing, or additional nozzles are not used, to achieve the different printing modes). In the illustrated embodiment, a first layer 604 of a structure 600 is formed using the accumulation printing mode 602 (e.g., d=approximately 420 μm with (H*, V*)=(approximately 1.5, approximately 0.4)), a second layer 606 is formed using the equi-dimensional mode 602′ (e.g., d=approximately 200 μm with (H*, V*)=(approximately 1.5, approximately 1.8)), and a third layer 608 is formed using the thinning mode 602″ (e.g., d=approximately 150 μm with (H*, V*)=(approximately 1, approximately 3.2)). The resulting structure 600 is a pyramid having layers with different properties due to the different printing modes used to form each layer. The present disclosure also contemplates using different printing modes in the same layer while producing a 3D structure, among other possible configurations.

In addition to the varied structures now possible in view of the present disclosures, methods for printing in three dimensions can likewise be improved. Such methods can include selecting printing modes based on the non-dimensional parameters V* and H*, and the parameters that impact these non-dimensional parameters. The selection can be done manually, by an operator, or can be automated, such as by a controller. The controller may receive desired parameters (e.g., V*, H*, and parameters that impact V* and H*) and print based on those parameters, or in the alternative, the controller can receive a desired result, such as desired printing mode to be achieved or a desired property for the resulting printed material to have (e.g., a certain level of stiffness, a particular formation or shape, etc.), and adjust the parameters (e.g., V*, H*, and parameters that impact V* and H*) to achieve the desired result. After the printing mode is selected, the material can be deposited from one or more nozzles based on the selected printing mode. The depositing can thus be done using any of the printing modes provided for herein, or otherwise derivable from the present disclosures, including: accumulation, translating coiling, alternating coiling, stretching coiling, meandering, die-swelling, equi-dimensional, thinning, and discontinuous. As discussed elsewhere, the controller can be capable of generating a phase diagram, like those provided for in FIGS. 6, 8A, and 10, and/or the phase diagram can be otherwise available to the controller to assist in selecting the best printing mode to produce the desired result.

Applications and Functionalities

The present disclosures allow for various applications and functionalities that were not achievable using conventional DIW printing. The ability to print diverse complex patterns with linear nozzle paths by coiling instability allows for new avenues to fabricate stretchable structures with tunable stiffening properties. For example, biological tissues can be fabricated that allow for the tissues to achieve delayed stiffening under deformation, similar to how natural biological tissue acts. This ability plays a critical role in the functionalities and structural robustness of the tissue.

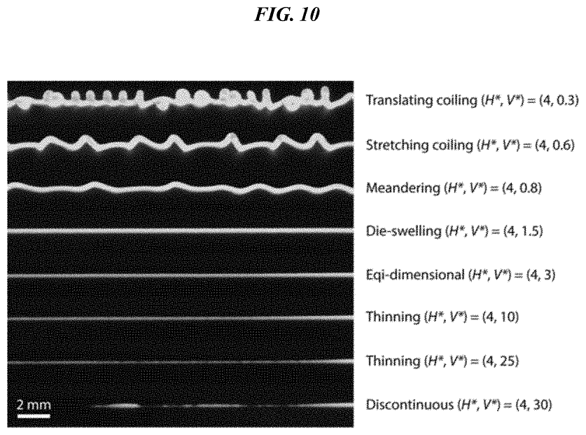

The present disclosures can be useful in various engineering applications, such as creating stretchable electronics. The fabrication of stretchable electronics prior to the present disclosure typically requires complicated, multi-step processes in small scales. However, in view of the present disclosures, stretchable structures with tunable stiffening property can readily be printed by harnessing instability of the viscoelastic ink. This is illustrated in FIGS. 11A-11C.

As shown in FIG. 11A, the stiffening response of the printed fiber can be tuned in a highly predictable manner by selecting appropriate printing parameters based on the phase diagram. More particularly, the locking stretch λ_{L} of printed fibers as a function of 1/V* under simple tension demonstrates how coils can be formed based on the value of V*, with the value of 1/V* being 1 yielding a relatively straight configuration and the value of 1/V* being 1.25 yielding a meandering configuration. The dots represent experimental data, and the solid line the predicted results based on the present disclosures, demonstrating an accurate correlation between the predicted and actual results.

Additionally, the same approach can realize structures with anisotropic stiffening property in different directions, all printed with a single nozzle. In one example, V* is selected to be 0.8 for both X and Y directions to create a meandering pattern or mode in both directions, resulting in the delayed stiffening responses in both directions, as shown in FIG. 11B, which provides a plot of force F as a function of stretch A for a 3D printed mesh. In another example, illustrated in FIG. 11C, which provides a plot of force F as a function of stretch λ for the 3D printed mesh, V* is selected to be 1.8 for the X-direction (equi-dimensional mode) while V* is selected to be 0.8 for the Y-direction (meandering mode), resulting in the delayed stiffening response only in the Y-direction.

The present disclosures also allow 3D structures with gradient properties to be produced. In conventional DIW printing, the printing of fibers with large range of diameters typically requires individually accessible nozzles with different diameters. The predictable control of fiber diameter afforded by the present disclosures, however, allows for a wide range of fiber diameters to be achieved without changing the nozzle. Instead, the printing parameters can be adjusted to achieve different diameters across a single fiber. More specifically, such gradient structures can be printed within the same layer of fibers by varying H* and V* when printing different fibers. For example, in some embodiments, such as a gradient mesh 1000 illustrated in FIG. 11D, V* can be varied from about 0.4 to about 3.2 within a same layer to print the mesh 1000 with the fiber diameter ranging from about 420 μm to about 150 μm.

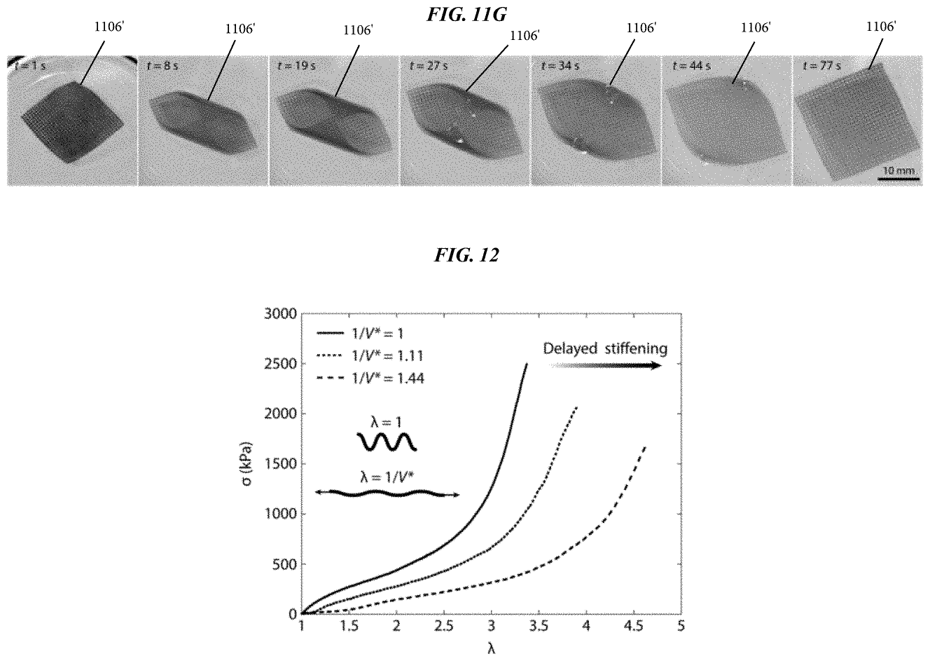

The gradient can also be introduced over different layers in a 3D structure by using different H* and V* values in different layers. For example, to print a 3D structure with different patterns and fiber diameters for each layer as shown in FIG. 13, discussed in further detail below. In another example, as shown in FIG. 11E, the values of H* and V* can be equal to 1.5 and 1, respectively, for layers 1 through 4, and 0.7 and 3, respectively, for layers 5 through 8 to print a 3D mesh with 8 layers.

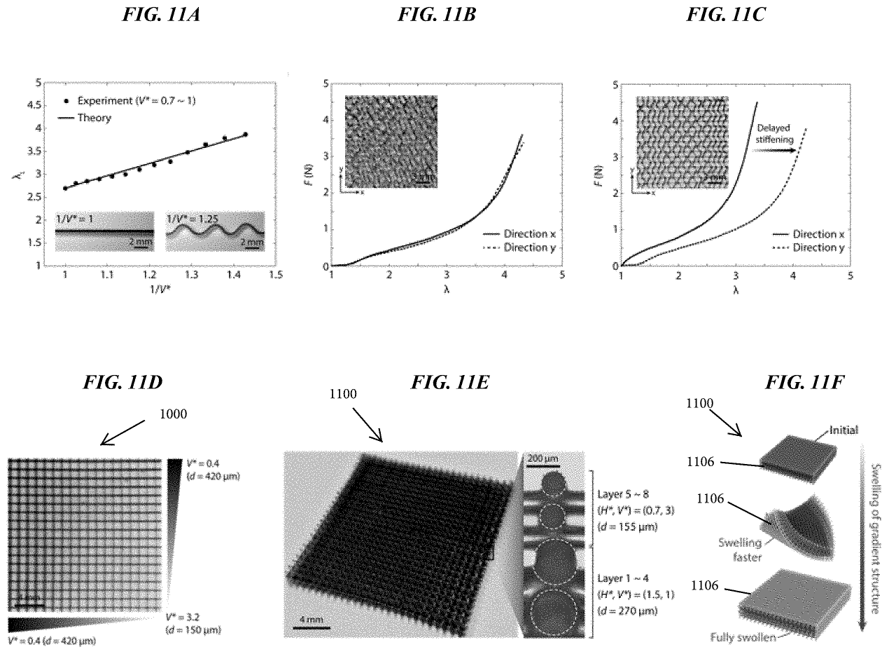

Further support for the delayed stiffening is provided for in FIG. 12, which provides for a plot of nominal stress a as a function of stretch A of printed fibers under tension. During the coiling mode of printing (1/H*<V*≤1), the total length of the printed fiber becomes 1/V* times of the translational movement of the nozzle tip due to the coiling instability. To straighten the resultant wavy fiber, it can be stretched to λ=1/V* during which tensile resistance is very low, resulting in the delayed stiffening under tension, as shown in FIG. 12. Accordingly, the locking stretch of the printed fiber can be expressed as:

λ_{L}=λ_{L0}/V* (9)

where λ_{L0} is the locking stretch of the fiber printed at V*=1. Delayed stiffening happens under tension due to initial stretching of the meandering patterns with low resistance. The delay stiffening is highly tunable in view of the present disclosures by selecting appropriate printing parameters based on a phase diagram.

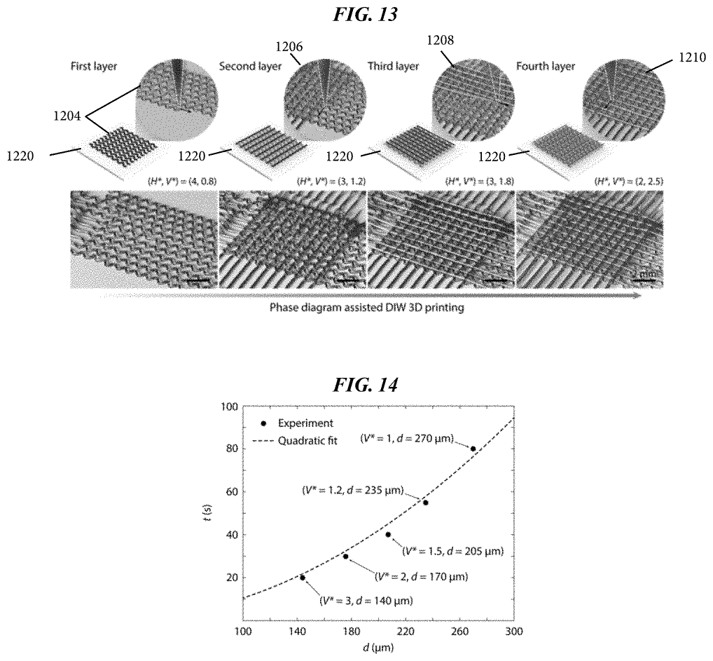

The 3D structures that can be printed as a result of the provided systems and methods can also have gradient kinetic properties that enable functions not previously achievable for 3D structures generated by DIW printing. For example, structures can be produced using fibers with different diameters have different equilibrium swelling time t, following the quadratic diffusion relation t˜d² shown in FIG. 14, and the diameter of fibers can be accurately controlled by use of a phase diagram, like the one illustrated in FIG. 6. More particularly with respect to FIG. 14, the illustrated graph plots an equilibrium swelling time t as a function of printed fiber diameter d in solvent. Printed fibers with various sizes exhibit gradient in swelling responses in a solvent like tetrahydrofuran (THF). In FIG. 15, the dots represent experimental data, and the dotted curve represents the quadratic diffusion relation, t˜d².

As a result, as shown in FIGS. 11E and 11F, a gradient 3D mesh 1100 having at least two different fiber diameters in an upper portion and a lower portion of the structure can be produced by a single nozzle. Further, a swelling actuator 1106 (FIG. 11F) can be part of the mesh 1100. When the actuator 1106 swells in a solvent (e.g., tetrahydrofuran), it can initially buckle towards one side and gradually becomes flat over time, as shown in FIG. 11F. This is due, at least in part, to the portions of the mesh 1100 having smaller fiber diameters swelling faster (e.g., d=155 μm and t≈20 s) than portions of the mesh 1100 having larger fiber diameters (e.g., d=270 μm and t≈80 s) while both portions have approximately the same equilibrium swelling ratio. FIG. 11G likewise demonstrates the initial buckling that can occur. More particularly, a response of a swelling actuator 1106′ is illustrated over time. As shown, the swelling actuator 1106′ is introduced to a solvent (e.g., tetrahydrofuran) at one second, and it can begin to buckle, as shown at the eight second mark. As time continues to pass, as shown at the 19 second, 27 second, 34, and 44 second marks, the actuator 1106′ gradually becomes flat over time. In the illustrated embodiment, the actuator 1106′ becomes approximately flat after approximately 77 seconds, but is now in a swelled condition.

FIG. 13 demonstrates a configuration of a 3D printed mesh different layers printed using different modes. As shown, a first layer 1204 is printed on a receiving plate 1220, with the values of H* and V* being equal to approximately 4 and approximately 0.8, respectively, to produce the meandering fiber configuration. A second layer 1206 is subsequently printed onto the first layer 1204, with the values of H* and V* for the second layer being equal to approximately 3 and approximately 1.2, respectively, to produce the die-swelling fiber configuration, in which a diameter of the fiber is greater than the diameter of the nozzle from which the fiber is extruded. In the illustrated embodiment, a third layer 1208 is printed onto the second layer 1206, with the values of H* and V* for the third layer being equal to approximately 3 and approximately 1.8, respectively, to produce the equi-dimensional fiber configuration, in which a diameter of the fiber is approximately equal to the diameter of the nozzle from which the fiber is extruded. Still further, in the illustrated embodiment a fourth layer 1210 is printed onto the third layer 1208, with the values of H* and V* for the fourth layer being equal to approximately 2 and approximately 2.5, respectively, to produce the thinning fiber configuration, in which a diameter of the fiber is thinner, or less, than the diameter of the nozzle from which the fiber is extruded.

One skilled in the art will appreciate further features and advantages of the disclosure based on the above-described embodiments. Accordingly, the disclosure is not to be limited by what has been particularly shown and described, except as indicated by the appended claims. All publications and references cited herein are expressly incorporated herein by reference in their entirety.

What is claimed is:

1. A method for printing in three dimensions, comprising:
selecting a printing mode based on at least one of a non-dimensional nozzle speed and a non-dimensional nozzle tip height in which the non-dimensional nozzle speed is based on both a nozzle speed and an extrusion speed, and the non-dimensional nozzle tip height is based on both a die-swollen diameter of material to be extruded from a nozzle and a combination of a height of a substrate configured to receive extruded material from the nozzle and a height of material disposed on the substrate; and
depositing material from the nozzle based on the selected printing mode.

2. The method of claim 1, wherein depositing material from the nozzle based on the selected printing mode further comprises depositing the material in one or more of the following manners: accumulation, translating coiling, alternating coiling, stretching coiling, meandering, die-swelling, equi-dimensional, thinning, and discontinuous.

3. The method of claim 1, further comprising:
generating a phase diagram for material to be printed from the nozzle, the phase diagram including a plurality of printing modes from which the printing mode is selected based on the non-dimensional nozzle speed and the non-dimensional nozzle tip height.

4. The method of claim 3, wherein at least one printing mode of the plurality of printing modes is based on a ratio that includes the non-dimensional nozzle speed and the non-dimensional nozzle tip.

5. The method of claim 3, wherein at least one printing mode of the plurality of printing modes is based on a comparison between the non-dimensional nozzle speed and a die-swelling ratio.

6. The method of claim 3, wherein at least one printing mode of the plurality of printing modes is based on a comparison between the non-dimensional nozzle speed and the actual nozzle speed.

7. The method of claim 1, wherein the material comprises a viscoelastic ink.

8. The method of claim 1, wherein selecting a printing mode based on at least one of a non-dimensional nozzle speed and a non-dimensional nozzle tip height further comprises selecting values of at least one of the non-dimensional nozzle speed and the non-dimensional nozzle tip height based on at least one of the following properties of the material to be deposited from the nozzle: a deformation of the material, an instability of the material, and a fracture of the material.

9. A three-dimensional printing system, comprising:
a printhead having one or more nozzles; and
a controller configured to operate the printhead to eject ink from the one or more nozzles towards a surface, the controller further being configured to print in a variety of different printing modes without changing hardware of the system, including hardware of the printhead and the one or more nozzles, the variety of different printing modes including accumulation, translating coiling, alternating coiling, stretching coiling, meandering, die-swelling, equi-dimensional, thinning, and discontinuous.

10. The three-dimensional printing system of claim 9, wherein the controller is further configured to print at least each of the variety of different printing modes that include accumulation, translating coiling, alternating coiling, stretching coiling, meandering, die-swelling, equi-dimensional, thinning, and discontinuous.

11. The three-dimensional printing system of claim 9, wherein the controller is further configured to select a printing mode from the variety of different printing modes based on at least one of a non-dimensional nozzle speed and a non-dimensional nozzle tip height of at least one nozzle of the one or more nozzles in which the non-dimensional nozzle speed is based on both a nozzle speed and an extrusion speed, and the non-dimensional nozzle tip height is based on both a die-swollen diameter of material to be extruded from the at least one nozzle and a combination of a height of a substrate configured to receive extruded material from the at least one nozzle and a height of material disposed on the substrate.

12. The three-dimensional printing system of claim 11, wherein the controller is configured such that it selects values of at least one of the non-dimensional nozzle speed and the non-dimensional nozzle tip height based on at least one of the following properties of the material to be deposited from the nozzle: a deformation of the material, an instability of the material, and a fracture of the material.

13. The three-dimensional printing system of claim 9, wherein the controller is further configured to generate a phase diagram for material to be printed from the one or more nozzles, the phase diagram including at least one printing mode from the variety of different printing modes.

14. The three-dimensional printing system of claim 13, wherein the phase diagram is based on at least one of a non-dimensional nozzle speed and a non-dimensional nozzle tip height of at least one nozzle of the one or more nozzles in which the non-dimensional nozzle speed is based on both a nozzle speed and an extrusion speed, and the non-dimensional nozzle tip height is based on both a die-swollen diameter of material to be extruded from the at least one nozzle and a combination of a height of a substrate configured to receive extruded material from the at least one nozzle and a height of material disposed on the substrate.

15. The three-dimensional printing system of claim 14, wherein at least one printing mode of the variety of different printing modes is based on a ratio that includes the non-dimensional nozzle speed and the non-dimensional nozzle tip.

16. The three-dimensional printing system of claim 14, wherein at least one printing mode of the variety of different printing modes is based on a comparison between the non-dimensional nozzle speed and a die-swelling ratio.

17. The three-dimensional printing system of claim 14, wherein at least one printing mode of the variety of different printing modes is based on a comparison between the non-dimensional nozzle speed and the actual nozzle speed.

18. The three-dimensional printing system of claim 9, wherein ink ejected by the one or more nozzles comprises a viscoelastic ink.

19. The three-dimensional printing system of claim 18, further comprising a viscoelastic ink, the viscoelastic ink being configured to be the ink ejected by the one or more nozzles.

20. A three-dimensional printing system, comprising:
a controller configured to select a printing mode based on at least one of a non-dimensional nozzle speed and a non-dimensional nozzle tip height in which the non-dimensional nozzle speed is based on both a nozzle speed and an extrusion speed, and the non-dimensional nozzle tip height is based on both a die-swollen diameter of material to be extruded from a nozzle and a combination of a height of a substrate configured to receive extruded material from the nozzle and a height of material disposed on the substrate; and
one or more nozzles for depositing material based on a print mode selected by the controller.

21. The three-dimensional printing system of claim 20, wherein the controller is configured to select a print mode from a plurality of print modes, the plurality of print modes including: accumulation, translating coiling, alternating coiling, stretching coiling, meandering, die-swelling, equi-dimensional, thinning, and discontinuous.

22. The three-dimensional printing system of claim 20, wherein the controller is further configured to generate a phase diagram for material to be printed from the one or more nozzles, the phase diagram including a plurality of printing modes from which the printing mode is selected based on the non-dimensional nozzle speed and the non-dimensional nozzle tip height.

23. The three-dimensional printing system of claim 22, wherein at least one printing mode of the plurality of printing modes is based on a ratio that includes the non-dimensional nozzle speed and the non-dimensional nozzle tip.

24. The three-dimensional printing system of claim 22, wherein at least one printing mode of the plurality of printing modes is based on a comparison between the non-dimensional nozzle speed and a die-swelling ratio.

25. The three-dimensional printing system of claim 22, wherein at least one printing mode of the plurality of printing modes is based on a comparison between the non-dimensional nozzle speed and the actual nozzle speed.

26. The three-dimensional printing system of claim 20, wherein the one or more nozzles is configured to deposit a viscoelastic ink based on a print mode selected by the controller.

27. The three-dimensional printing system of claim 26, further comprising a viscoelastic ink, the viscoelastic ink being configured to be deposited by the one or more nozzles.

28. The three-dimensional printing system of claim 20, wherein the controller is configured such that it selects values of at least one of the non-dimensional nozzle speed and the non-dimensional nozzle tip height based on at least one of the following properties of the material to be deposited from the nozzle: a deformation of the material, an instability of the material, and a fracture of the material.
